(19) United States
(12) Patent Application Publication
(10) Pub. No.: US 2015/0083658 A1
(43) Pub. Date: Mar. 26, 2015

(54) METHOD FOR THE PRODUCTION OF A FILTER MEMBRANE AND FILTER MEMBRANE

(71) Applicant: Ewald Dörken AG, Herdecke (DE)

(72) Inventors: Jörn Schröer, Herdecke (DE); Daniel Placke, Dortmund (DE)

(73) Assignee: Ewald Dörken AG, Herdecke (DE)

(21) Appl. No.: 14/372,560

(22) PCT Filed: Jan. 15, 2013
(86) PCT No.: PCT/EP2013/000098

§ 371 Date: Jul. 16, 2014

(30) Foreign Application Priority Data
Jan. 16, 2012 (DE) 10 2012 000 577.6
Jan. 27, 2012 (DE) 10 2012 001 544.5

(51) Int. Cl. B01D 71/26; B01D 67/00; B29D 99/00; B01D 69/12

(52) U.S. Cl. CPC B01D 71/26; B01D 69/12; B01D 67/0088; B29D 99/005; B29K 2023/0633
USPC 210/490; 264/210.6

(57) ABSTRACT

A method for the production of a filter membrane (1), whereby as starting material for the membrane production, at least one filler (3) and, optionally, at least one additional aggregate are admixed into a polymer membrane material (2), whereby the membrane material (4) that has the filler (3), and optionally the additional aggregate, is extruded to form a polymer film (5) that is charged with the filler (3), and optionally, the additional aggregate, after which the polymer film (5) is then stretched in a particularly monoaxial and/or biaxial manner for pore formation.

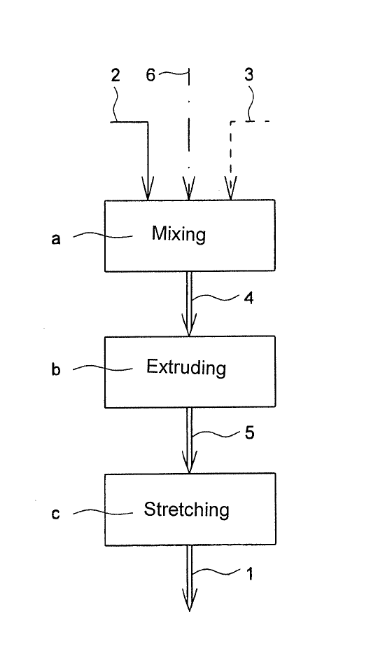

### BACKGROUND OF THE INVENTION

1. Field of the Invention

The invention relates to a method for the production of a filter membrane and a filter membrane that can be obtained in accordance with the method according to the invention.

2. Description of Related Art

(Micro-)porous filter membranes are used in a host of fields of industrial, pharmaceutical or medical applications for precision filtration. In these applications, membrane based separation processes are gaining increasing importance since these processes offer the advantage that the substances to be separated are not heat-stressed or even damaged. For example, microfiltration membranes make it possible to remove fine particles or microorganisms with sizes of up to the submicron range and are therefore suitable, for example, for the production of purified water for use in laboratories or for the semiconductor industry. Numerous other applications of membrane based separation processes are known from the beverage industry, for example for clarifying beverages, biotechnology or waste-water technology, for example for treating process waste water or for separating digestates, as well as for purifying waste water of all types. Additional possible applications are oil/water separation, pervaporation, gas and vapor permeation, and solid/liquid separation in general. Moreover, use as a water-permeable and water-vapor-permeable carrier material is possible, for example for mechanical stabilization of membranes. Such membranes are also used in the textile industry.

In order to be able to perform the filtration quickly, effectively, and economically, high (through) flow rates of the permeate with the lowest possible pressure differentials over the membrane must be achieved. In this case, known commercially available microfiltration membranes make possible flow rates in the range of approximately 100 l/(m²h bar). In addition, thermal stability and chemical stability are required in order to be able to use the membrane in a wide temperature and pH range. This is also of decisive importance for, i.a., the cleanability of the membranes by acids, lyes or other chemicals. Typical materials, from which filter membranes are produced, are, for example, polytetrafluoroethylene (PTFE), polyvinylidene fluoride (PVDF), polysulfone (PSU) or polypropylene (PP), whereby the above-mentioned list is not exhaustive.

Various methods are known for the production of filter membranes from a polymer starting material. Primarily the phase inversion process and the elongation of partially crystalline polymer films are of commercial importance.

With the phase inversion process, the polymer is dissolved in a solvent, the solution is coated with a doctor knife or poured to form a film, dipped into a bath with a non-solvent or coagulating agent, and then dried. One drawback of this process is that the use of organic solvent is necessary, and the process comprises several process steps, which makes the production of membranes production-intensive and costly. Moreover, the process is largely limited to the use of readily soluble polymers, such as PVDF or PSU.

Another method for the production of porous membranes is the elongation of partially crystalline polymer films, for example made of PP or PTFE. Elongated PTFE membranes are known, for example, under the trade name Gore-Tex® (W. L. Gore & Associates). Elongated PP membranes are available under the trade name Celgard® (Celgard). For the production of the above-mentioned polymer films, special highly-crystalline polymers are extruded under high shearing forces, elongated in a monoaxial or biaxial manner in an additional step at high temperatures, and then cooled under tension. The previously-described method is labor-intensive and costly in terms of processing based on numerous processing steps, such as film-forming, heating, stretching and controlled cooling under tension. The high temperatures during stretching of the polymer films and high raw material costs contribute to high production costs of the known membranes.

### SUMMARY OF THE INVENTION

A primary object of this invention is to provide a method of the above-mentioned type, which allows a simple and economical production of filter membranes in terms of processing. The membranes produced in accordance with the method according to the invention are intended to be able to be used especially advantageously for microfiltration based on good separating properties. In particular, the membranes according to the invention are to make possible filtration at high flow rates.

To achieve the above-mentioned objects, it is provided in a method for the production of a filter membrane that at least one filler and, optionally, at least one additional aggregate are to be admixed into a polymer membrane material as a starting material for the membrane production in such a way that the membrane material that has the filler and optionally the additional aggregate is extruded to form a polymer film and so that the polymer film is then stretched in particular in a monoaxial and/or biaxial manner for pore formation.

Relative to the known state of the art for the production of filter membranes, the method according to the invention offers a number of advantages. Thus, the method according to the invention allows for a very economical production of microfiltration membranes since inexpensive standard polyolefins can be used, no organic additives such as solvents are used, and/or the film extrusion and the stretching can be performed continuously and inline at high speed on a single machine segment. The method according to the invention makes possible, moreover, the use of different polymer membrane materials as starting substances for the membrane production and the use of different fillers and optionally additional aggregates over broad concentration ranges. As a result, the separating properties of the filter membranes that can be obtained in accordance with the method according to the invention, which are determined by, for example, the pore diameter, the porosity, the chemical, thermal or pH stability, the colors and (through) flow rates, can be modified in order to adapt the separating properties in a targeted fashion to a specific separating object. In this connection, the method according to the invention also makes possible in a simple way the addition of a host of aggregates and additives to the membrane material, such as, for example, the addition of dyes or stabilizers. Moreover, flow rates>100 l//(m²h bar) and in particular greater than 150 l/(m²h bar) are readily possible with such a membrane.

### BRIEF DESCRIPTION OF THE DRAWINGS

The sole figure of the drawings is a flow chart of the steps for producing a microfiltration membrane in accordance with the present invention.

### DETAILED DESCRIPTION OF THE INVENTION

By the selection of specific polymer membrane materials as starting substances for membrane production and different fillers and optionally additional aggregates, and by variation of the concentrations of the starting materials, fillers, and other aggregates used, the separating properties of the membrane can be preset in such a way that the membranes according to the invention can be used especially advantageously for the filtration of aqueous waste water or process water, for beverage filtration or sterile filtration, for oil/water separation, as well as for the filtration of acids, lyes or other chemicals.

For the production of the polymer films or polymer membranes according to the invention, in principle any extrudable polymers or polymer mixtures can be used as a polymer membrane material. Economical standard polymers are preferably used, such as polyolefins and their copolymers, such as, for example, highly-branched polyethylene or low-density polyethylene (LDPE), linear polyethylene of low density (LLDPE), polypropylene or polypropylene-heteropolymers. In particular, at least one substance of the membrane material is selected from the group of
(i) Polyolefins;
(ii) Copolymers of polyolefins;
(iii) Mixtures of polyolefins and their copolymers; and
(iv) Polymer mixtures, comprising at least 10% by weight of polyolefins and/or their copolymers, relative to the polymer mixture.

Introducing filler into the polymer membrane material can be done by batch or intermittently in a batch process. In order to further simplify the method according to the invention and to reduce process costs, the admixing of filler particles to form polymers is preferably carried out, however, by inline compounding, for example in a twin-screw extruder or co-kneader, namely a single-screw extruder, which executes both a rotating movement and a back-and-forth movement. When the filler is introduced, the filler particles are embedded in a polymer matrix and thus are immobilized, distributed as much as possible, in the membrane material.

After the admixing of the filler and optionally at least one additional aggregate, the polymer membrane material is extruded to form a polymer film. Admixing is also possible during film extrusion. In the case of the film extrusion, different die geometries can be used, for example flat-sheet dies, in particular of the so-called “coat hanger”-type, or round dies, whereby flat-sheet dies are preferred. Also, the production of blow-extrusion films is possible by extrusion. If necessary, at least two plastic melts having different amounts of filler and/or different filler particles can be coextruded to form a polymer film. Filler-free and filler-containing plastic melts can also be coextruded to form a polymer film.

In terms of the invention, the term “co-extrusion” is defined as the merging of similar or foreign plastic melts before leaving the profile die of the extruder. Multiple-layer polymer films can be produced by co-extrusion, whereby a filler-containing functional layer can be produced with one or more cover layers with deviating filler content or with another type of filler. The cover layers can be used, for example, for mechanical, thermal or chemical stabilization of the polymer film, to improve the gluability or weldability of the microfiltration membrane according to the invention, or to produce porosity gradients within the microfiltration membrane.

Before the stretching, the thickness of the extruded polymer film is preferably between 5 and 300 μm, more preferably between 20 and 250 μm, and especially preferably between 30 and 200 μm. Subsequently, there is then another thickness reduction by the stretching or elongation of the polymer film.

The extruded polymer film is elongated or stretched in a monoaxial or biaxial manner according to the invention in at least one process step subsequent to the film extrusion, which results in pore formation. During the stretching, holes, which form pores of the membrane, pull at the boundary between the filler particles and the polymer matrix. The elongation or stretching can preferably be carried out inline, for example monoaxially, in an elongating unit that is formed of several pairs of rollers. As a result, continuous production of a microfiltration membrane according to the invention at high speed on a machine segment is possible, which contributes to low production costs. As an alternative, monoaxial or biaxial offline stretching, for example in a stretcher, is also possible.

The extruded and elongated polymer film contains the filler in a concentration of between 20 and 90% by weight, preferably between 30 and 80% by weight, and especially preferably between 40 and 70% by weight, in each case relative to the total weight of the polymer film.

As filler, in particular, an inorganic filler is suitable, in addition in particular from the group of carbonates, preferably calcium carbonate, magnesium carbonate, sodium carbonate or barium carbonate; and/or from the group of silicon dioxides and silicates, preferably magnesium silicate hydrate (talc), mica, feldspar or glasses; and/or from the group of sulfates, preferably calcium sulfate, magnesium sulfate, barium sulfate, or aluminum sulfate. As an alternative or in addition, an organic filler, in particular from the group of polymers, can be admixed into the polymer membrane material. It is understood that mixtures and combinations of the above-mentioned groups and compounds can also be used as filler(s). As filler, calcium carbonate in the form of calcite (lime spar) and/or aragonite, in particular as natural rock in the form of limestone or chalk, is especially preferably admixed. By using the last-mentioned fillers, microfiltration membranes can be produced with especially good separating properties. In particular, the thus obtained microfiltration membranes are distinguished by high flow rates and low raw material costs.

An especially preferred embodiment relates to a polymer film, which contains 40 to 70% by weight of calcium carbonate and 30 to 60% by weight of PP, LDPE, or LLDPE as well as mixtures of the latter.

In principle, particulate fillers with a mean particle diameter of less than 10 win, preferably 0.1 to 8 μm, and especially preferably 1 to 5 μm, are suitable. Based on the filler that is used, the amount of filler, and/or the particle size, the separating properties of the microfiltration membrane according to the invention can change in a variety of ways and can be adapted to the separating object. Thus, for example, the porosity, the pore diameter, the heat conductivity, and the electrical conductivity of the microfiltration membranes according to the invention can be set and preset within a wide range.

During the stretching of the polymer film, the temperatures can lie between 20 and 180° C. below the melting point or softening point of the matrix polymer that is used, preferably between 40° C. and 120° C., and especially preferably between 50° C. and 110° C., below the melting point or softening temperature of the matrix polymer that is used. The method according to the invention is thus distinguished by moderate operating temperatures during stretching, which simplifies the method and further reduces the production costs of the microfiltration membrane according to the invention.

The stretching can be done by a factor of between 1.5 and 7, preferably between 2 and 5, and especially preferably between 2 and 4. As a result, the thickness of the membrane and the separating properties, in particular the desired pore size, can vary within wide ranges and be adapted to the separating object.

The method according to the invention allows in a simple way the addition of further aggregates and additives before or during film extrusion of the polymer that is used. The merging of membrane material and aggregates can be provided at the same time with the admixing of fillers into the membrane material or after the filler admixing. The incorporation of the filler and additional aggregates into the membrane material can be done by, for example, the mixing of melts.

In this connection, an intrinsic hydrophilization of the polymer before or during film extrusion can be achieved by admixing at least one hydrophilization additive into the polymer membrane material. Hydrophilization improves the uptake of moisture by the membrane, in particular the uptake and the passage of liquid water, and higher flow rates during filtration are ensured, which is advantageous in particular when using hydrophobic polymers as membrane materials. Liquids with high surface tension, such as, for example, water, can thus wet the pores of the hydrophilized membrane according to the invention and can penetrate the membrane. The membrane according to the invention thus is suitable in particular for the microfiltration of aqueous suspensions at high (through) flow rates.

An intrinsic hydrophilization of the microfiltration membrane according to the invention results in a number of advantages. The method according to the invention makes it possible, on the one hand, to introduce the hydrophilization additive in a single-stage method. In the method that is known from the state of the art, at least two process steps are necessary in this respect, since the hydrophilization additive is applied only after the membrane is produced, for example by padding. Then, a so-called “run-in” of the membrane is necessary, in which the hydrophilization additive that is located in the pores is successively exposed to several hours of flushing with clear water and is replaced by water. The intrinsic hydrophilization that is provided according to the invention does not, however, require running in the membrane, which saves time and money. By mixing the hydrophilization additive into the melts, a permanently intrinsic hydrophilization is achieved. In contrast to the method that is known from the state of the art, the hydrophilization additive according to the invention cannot be washed away from the surface of the membrane over time. This provides for a longer service life of the membrane, which reduces the expense for maintenance and repairs. Also, drying-out of the microfiltration membrane according to the invention is readily possible, since in contrast to the subsequently hydrophilized membranes known from the state of the art, no run-in by preliminary wetting is necessary.

In a preferred embodiment, an amphiphilic hydrophilization additive is added. The hydrophilization additive can be an (amphiphilic) surfactant, in particular an anionic, cationic, non-ionic or cationic-anionic surfactant. By using the above-mentioned additives, a very effective intrinsic hydrophilization is possible at low costs. Suitable hydrophilizing agents are amphiphilic substances and surfactants with a molecular weight of less than 100,000 Daltons, which can be mixed with the starting polymer that is used.

In the case of an advantageous embodiment of the method according to the invention, an amphiphilic hydrophilization additive is used, which has at least one alkyl, acyl, aryl and/or arylacyl radical, coupled with a heteroatom-containing group, in particular from the group of glycols, polyoxyethylenes, sulfides, sulfonates, amines, amides, phosphonates and phosphates. Such hydrophilization additives can be present in the form of master batches or granulates, which have different compositions.

It has been shown to be especially advantageous when a hydrophilization additive with the general composition CH₃CH₂—(CH₂CH₂)x-(OCH₂CH₂)y-OH is used, whereby x and y usually can attaom values of between 1 and 20. Examples in this respect are the products Irgasurf®HL562 (Ciba Speciality Chemicals) and Unithox™550 (Baker Hughes). As an alternative, perfluoroalkyl compounds with an anionic methacrylate end group can be used as hydrophilization additives. ZONYL®7950 (DuPont Speciality Chemicals) belongs to such hydrophilization additives. Similar compounds, which instead contain acrylate, phosphate, or amine end groups, can also be used.

In this connection, in addition to the at least one filler, the microfiltration membrane according to the invention can contain between 0.1 and 20% by weight of at least one suitable hydrophilization additive, preferably between 0.5 and 15% by weight, and especially preferably between 1 to 10% by weight of the hydrophilization additive. In addition, the invention comprises microfiltration membranes, which contain an especially hydrophilic filler with a concentration of between 10 and 90% by weight, preferably between 30 and 80% by weight, and especially preferably between 45 and 70% by weight, and at least one hydrophilization additive with a concentration of between 0.1 and 15% by weight, preferably between 0.5 and 10% by weight, and especially preferably between 0.5 to 8% by weight. In terms of the invention, hydrophilic fillers are defined as all fillers that are suitable to increase the wettability of the polymer by polar interactions with water. To this end, in particular inorganic fillers of an ionic and non-ionic nature are suitable, as well as all particles that have a permanently polar surface because of surface modification. Conceivable hydrophilic fillers are, for example, silicic acids, salts, or correspondingly surface-modified polymer particles.

A preferred embodiment of the invention relates to a polymer film, which has 40 to 70% by weight of calcium carbonate, 1 to 10% by weight of a hydrophilization additive, and 20 to 59% by weight of PP, LDPE, or LLDPE, as well as mixtures of the latter.

The microfiltration membrane that can be obtained in accordance with the method according to the invention makes possible the filtration at high flow rates, whereby when using tap water, flow rates of at least 100 l/(m²h bar), preferably at least 130 l/(m²h.bar), and especially preferably at least 150 l/(m²h bar) are achieved. Higher flow rates are possible and are advantageous. The microfiltration membranes according to the invention can have pore sizes in a range of 0.1 to 5 μm, preferably in a range of 0.1 to 2 μm, and especially preferably in a range of between 0.2 and 1 μm. The porosity of the microfiltration membrane according to the invention is in this case at least 30%, preferably at least 40%.

### EXAMPLES

This invention is described in more detail by the preferred embodiments below, which in no way limit this invention, however. The properties indicated in the preferred embodiments were determined with the following test methods. The measurement of the flow rate was done with a membrane test stand (“Memcell,” Osmo Membrane Systems), in which the membrane in the cross-current method was exposed to pressures of 0.1 to 64 bar. The permeate was collected, and the flow rate was calculated from the permeate amount per minute. All flow rates were standardized to the unit 1/(m²h.bar). As a concentrate, a one-percent titanium dioxide suspension with a mean particle diameter of 0.5 μm was used. The success of the membrane filtration allowed optical confirmation based on clear permeate.

### Example 1

LDPE was used as a polymer membrane material for the production of a polymer film. Chalk was admixed into the membrane material as filler with a mean particle diameter of approximately 2 μm. Then, the thus obtained mixture was extruded for forming the polymer film. The chalk content of the polymer film was 65% by weight, and the LDPE content was 35% by weight. The thickness of the polymer film was 90 μm. The polymer film was stretched by a factor of 4 at 85° C., and the thickness of the polymer film was then 25 μm. The flow rate of the polymer film at a pressure differential of 5 bar was 160 l/(m²h bar), and the permeate was free of turbidity.

### Example 2

LDPE was used as a polymer membrane material for the production of a polymer film. Mica was admixed into the membrane material as filler with a mean particle diameter of approximately 8.5 μm. Then, the thus obtained mixture was extruded for forming the polymer film. The mica content of the polymer film was 55% by weight, and the LDPE content was 45% by weight. The thickness of the polymer film was 150 μm. The polymer film was stretched by a factor of 3 at 110° C., and the thickness of the polymer film was then 50 μm. The flow rate of the polymer film at a pressure differential of 5 bar was 120 l/(m²h bar), and the permeate was free of turbidity.

### Example 3

PP was used as a polymer membrane material for the production of a polymer film. As filler with a mean particle diameter of approximately 5 μm, barium sulfate and calcium sulfate were admixed into the membrane material. Then, the thus obtained mixture was extruded for forming the polymer film. The barium sulfate content of the polymer film was 25% by weight, the calcium sulfate content of the polymer film was 25% by weight, and the PP content was 50% by weight. The thickness of the polymer film was 100 μm. The polymer film was stretched by a factor of 3.5 at 110° C., and the thickness of the polymer film was then 30 μm. The flow rate of the polymer film at a pressure differential of 5 bar was 200 l/(m²h.bar), and the permeate was free of turbidity.

### Example 4

LLDPE was used as a polymer membrane material for the production of a polymer film. As filler with a mean particle diameter of approximately 2 μm, chalk and a hydrophilization additive (Unithox™ 550—Baker Hughes) were admixed into the membrane material. Then, the thus obtained mixture was extruded for forming the polymer film. The polymer film had a proportion of 65% by weight of chalk, 5% by weight of hydrophilization additive, and 30% by weight of LLDPE. The thickness of the polymer film was 90 μm. The polymer film was stretched by a factor of 3.6 at 70° C. The thickness of the polymer film was then 25 μm. The flow rate of the membrane at a pressure differential of 0.25 bar was 810 l/(m²h bar), and the permeate was free of turbidity.

### Example 5

PP was used as a polymer membrane material for the production of a polymer film. As filler with a mean particle diameter of approximately 1.4 p.m, chalk and a hydrophilization additive (Irgasurf®HL562—Ciba Speciality Chemicals) were admixed into the starting material. Then, the thus obtained mixture was extruded for forming the polymer film. The polymer film had a proportion of 60% by weight of chalk, 8% by weight of hydrophilization additive, and 27% by weight of PP. The thickness of the polymer film was 150 μm. The polymer film was stretched by a factor of 3.5 at 95° C. The thickness of the polymer film was then 47 μm. The flow rate of the polymer film at a pressure differential of 0.75 bar was 310 l/(m²h bar), and the permeate was free of turbidity.

### Example 6

As a polymer membrane material for the production of a polymer film, a polymer mixture of LLDPE and LDPE was used. As filler with a mean particle diameter of approximately 5 μm, barium sulfate and a hydrophilization additive (Unithox™550 Baker Hughes) were admixed into the membrane material. Then, the thus obtained mixture was extruded for forming the polymer film. The polymer film had a proportion of 55% by weight of barium sulfate, 5% by weight of hydrophilization additive, 30% by weight of LLDPE, and 10% by weight of LDPE. The thickness of the polymer film was 120 μm. The polymer film was stretched at 90° C. by a factor of 3, and the thickness of the polymer film was then 43 μm. The flow rate of the polymer film with a pressure differential of 0.5 bar was 230 l (m²h.bar), and the permeate was free of turbidity.

### Example 7

A polymer mixture of LLDPE and LDPE was used as a polymer membrane material for the production of a polymer film. As filler with a mean particle diameter of approximately 8.5 μm, mica and a hydrophilization additive (ZONYL®7950—DuPont Specialty Chemicals) were admixed into the membrane material. Then, the thus obtained mixture was extruded for forming the polymer film. The polymer film had a proportion of 50% by weight of mica, 4% by weight of hydrophilization additive, 16% by weight of LLDPE, and 30% by weight of LDPE. The thickness of the polymer film was 120 μm. The polymer film was stretched by a factor of 4 at 60° C., and the thickness of the polymer film was then 29 μm. The flow rate of the polymer film at a pressure differential of 0.25 bar was 875 l/(m²h.bar), and the permeate was free of turbidity.

The invention allows the features of the invention can be combined with one another, even if the combination is not described in detail. The above indications of value and the indicated intervals in each case encompass all values, i.e., not only the lower limits or, in the case of intervals, the interval limits, without the latter requiring express reference.

Below, a variant embodiment of a method according to the invention for the production of a microfiltration membrane is explained in the example of the figure. The invention is not limited to the depicted variant embodiment. If necessary, features of the depicted variant embodiment can be combined with the above-described features and/or the features mentioned in the claims.

The single figure diagrammatically shows the process sequence of a method for the production of a microfiltration membrane 1. In a first process step a, the depicted method calls for a polymer membrane material 2, which represents the starting material of the membrane production, to be mixed with at least one filler 3. In the mixture, the membrane material 2 forms a polymer matrix for the filler 3. The membrane material 4 that is obtained in the process step a and that has the filler 3 is then extruded in a process step b to form a filler-charged polymer film 5. The mixing of the filler 3 into the membrane material 2 and the extruding of the polymer film 5 can be done by inline compounding by means of a double-screw extruder or the like.

The polymer film 5 is stretched in a monoaxial or biaxial manner in a third process step c for pore formation, which can also be done inline in an elongating unit that is downstream from the extruding device.

It can optionally be provided to admix at least one hydrophilization additive 6 into the membrane material 2 in addition to the filler 3. As a result, it can be achieved that liquids with high surface tension, such as, for example, water, can wet the pores of the microfiltration membrane 1 and can penetrate the microfiltration membrane 1 at high flow rates, which is in particular of importance when a hydrophobic membrane material 2, such as, for example, PTFE, PVDF and PP, is used as starting material for the membrane production.

1-11. (canceled)

12. Method for the production of a filter membrane, comprising the steps of:
admixing at least one filler into a polymer membrane material as a starting material for membrane production,
extruding the membrane material with the admixed at least one filler to form a polymer film that is charged with the at least one filler, and
stretching the polymer film in at least one of a monoaxial and biaxial manner to form pores.

13. Method according to claim 12, wherein at least one aggregate is also admixed into the polymer membrane material in said admixing step.

14. Method according to claim 12, wherein at least one substance of the membrane material is selected from the group consisting of:
(i) Polyolefins;
(ii) Copolymers of polyolefins;
(iii) Mixtures of polyolefins and their copolymers; and
(iv) Polymer mixtures comprising at least 10% by weight relative to the polymer mixture of at least one of polyolefins and their copolymers,.

15. Method according to claim 12, wherein the filler in the polymer film constitutes of 20 to 90% by weight of the total weight

16. Method according to claim 12, wherein the filler in the polymer film constitutes of 40 to 70% by weight of the total weight of the polymer film.

17. Method according to claim 12, wherein material from at least one of the group of carbonates, the group of silicon dioxides and silicates, the group of sulfates, the group of polymers, and a mixture and combination of materials from said groups is used as the filler.

18. Method according to claim 12, wherein a filler with a mean particle diameter of less than 10 μm is used.

19. Method according to claim 12, wherein the stretching step is performed at a temperature between 20 and 180° C. below the melting point and the softening point of the polymer membrane material.

20. Method according to claim 12, wherein the stretching step is performed so as to stretch the polymer film by a factor of between 1.5 and 7.

21. Method according to claim 13, wherein, before or during film extrusion, at least one hydrophilization additive is added as an additional aggregate to the polymer membrane material,

22. Method according to claim 21, wherein the hydrophilization additive is an amphiphilic hydrophilization additive

23. Method according to claim 21, the hydrophilization additive is a surfactant.

24. Method according to claim 22, wherein the amphiphilic hydrophilization additive has at least one alkyl, acyl, aryl and/or arylacyl radical, coupled to a heteroatom-containing group, from the group of glycols, polyoxyethylenes, sulfides, sulfonates, amines, amides, phosphonates and phosphates.

25. Method according to claim 21, wherein a proportion of the hydrophilization additive in the polymer film is 0.1 to 20% by weight.

26. Filter membrane produced by the method according to claim 12.
